(19) United States
(12) Patent Application Publication
(10) Pub. No.: US 2004/0210886 A1
(43) Pub. Date: Oct. 21, 2004

(54) Optimized switch statement code employing predicates

(76) Inventors: Sverre Jarp, Cheserex (CH); Dale Morris, Steamboat Springs, CO (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/414,706

(22) Filed: Apr. 15, 2003

(51) Int. Cl. G06F 7/38

(52) U.S. Cl. 717/159; 712/226

(57) ABSTRACT

A method for coding a switch based on a variable is provided. The method includes copying a nonzero bit from a setting register to a corresponding bit in a rotating predicate register by moving said bit into the rotating predicate register, and performing a single case function computation based on the corresponding bit in the rotating predicate register. Alternately, the method may comprise using a register rename base value modulo summed with a virtual predicate file to rename the predicate register. In certain conditions, the design may include testing values being moved into the static predicate or rotating predicate register to determine whether the value exceeds an acceptable range.

### BACKGROUND OF THE INVENTION

1. Field of the Invention

The present invention relates generally to the field of computing, and more specifically to the execution of switch statements in high speed computer architectures.

2. Description of the Related Art

Certain newer computing devices employ high speed architectures having highly efficient computation and fast throughput. One such high speed computing architecture is the Itanium architecture, a joint development between Intel Corporation of Santa Clara, Calif. and Hewlett Packard Corporation of Palo Alto, Calif., the assignee of the present invention. The Itanium architecture employs EPIC (Explicitly Parallel Instruction Computing), a technology enabling enhanced performance over previously known RISC architectures. Features and a general discussion of the Itanium 2 processor can be found at:

http://h21007.www2.hp.com/dspp/files/unprotected/litanium2.pdf

The Itanium architecture conforms to various Itanium Architecture developer's guides, user manuals, reference guides, and related publications, including but not limited to Intel Itanium architecture Order Numbers 245317-004, 245318-004, 245319-004, 245320-003, 249634-002, 250945-001, 249720-007, 251141-004, 248701-002, 251109-001, 245473-003, and 251110-001.

A conceptual arrangement of a system employing the Itanium architecture is illustrated in FIG. 1. As used herein, the Itanium architecture may be embodied in different implementations, including but not limited to the Itanium processor and Itanium 2 processor. From FIG. 1, processor 102 resides in computing apparatus 101. Processor 102 employs a series of register files. Register files may take different forms, including but not limited to a general register file 110 and a predicate register file 111. Predicate registers are individual one bit registers and each predicate register forms part of a predicate register file. As shown in FIG. 1, a set of 64 predicate registers forming predicate register file 111 can be employed. 16 predicate registers are static registers 112 and are statically addressed, meaning that the register number used in instructions to reference a particular predicate register always maps to the same register location. The 48 remaining predicate registers are rotating predicates 113 and are discussed in more detail below. Multiple versions of each register and register file may be employed within the design. The system further includes a compiler 114 that compiles code and facilitates the execution of compiled computer code to interact with and between the aforementioned registers and register files.

Code employed in high speed architectures performs various computing tasks, such as testing variables and executing N blocks of code based on the result of the test. Typical constructs for code in C computer language are switch statements such as that shown in FIG. 2A. An alternate construct is the code illustrated in FIG. 2B. From FIG. 2A, in a situation where the variable in the switch statement is VALUE1, the system executes code block 1, if VALUE2, code block 2 is executed, and so forth. FIG. 2B employs if-then-else statements to evaluate the variable and execute the applicable code block.

Compiler code generated according to FIGS. 2A and 2B includes small blocks of machine code corresponding to the source code blocks (code block 1, code block 2, and so forth in FIGS. 2A and 2B). The compiler 114 then enables compares and conditional branches to branch to the proper block of code for execution.

This style of coding and compiling of switch statements has performed adequately in previous architectures. The sequential evaluation of FIG. 2A and the if-then-else construct of FIG. 2B do not provide the processor with the next instruction until the processor has completed the branch instruction. In other words, performance of code block 3 in FIG. 2A requires sequentially performing comparisons against VALUE1, VALUE2 and VALUE3. The processor executes each comparison in sequence, and cannot reach case statement 3 until it has determined that neither of the preceding case statements is to be executed. Prior processors only executed one instruction at a time, so small individual code blocks did not present any significant timing delay problems.

Branch prediction is the process of predicting whether a branch instruction will execute or not based on prior history. If the branch instruction has executed the last eight times, chances are high that the branch instruction, when fetched again, will also execute. The processor decides which instruction to load into the pipeline based on this prediction to increase efficiency. Prediction occurs before the evaluation or testing within the switch statement. A “penalty” for branch prediction occurs when the processor predicts incorrectly. When incorrectly predicted, the processor flushes the pipeline and discards all calculations based on the prediction. If the prediction was correct, the processor saves significant time.

With short pipelines and small penalties for incorrect branch prediction, the time delay associated with completion of a branch instruction is relatively insignificant. Newer processors, however, use increased pipeline lengths. More parallel processing is employed as well, resulting in significantly deeper and wider pipelines. The result is reduced efficiencies for switch code instructions for two significant reasons. First, incorrect branch prediction in newer processors yields increased time penalties. Previous scalar short pipeline processors could lose one instruction cycle in the event of a mispredicted branch. In the examples illustrated in FIGS. 2A and 2B, this misprediction could result in the loss of three cycles of time. Modem processors may have misprediction penalties of eight cycles, for example, with execution widths of approximately six instructions, for an opportunity cost or loss on the order of 48 execution slots. Secondly, it is extremely beneficial to maximize code parallelism, or perform multiple operations in parallel during a single processing cycle. Use of small code blocks in switch statements significantly restricts the amount of parallelism that can be employed in compiled code. The result is low functional unit utilization and low performance.

Previous attempts to enhance performance in the aforementioned architecture include moving work from case statement bodies and performing the work speculatively and in parallel outside the switch statement. Such optimizations can function effectively only where instructions can be speculated. However, case statement bodies frequently contain store commands and other operations not suited to speculation. Thus while moving work from case statement bodies may increase parallelism outside the switch statement, this approach leads to smaller case statement bodies with poor parallelism and does not address performance loss due to branch mispredictions.

Another approach has been to perform a set of compare instructions, one for each case statement, generating a set of predicates for each case statement body. Instructions from each case statement body can then be scheduled together, free of branches. This approach addresses the problems of branch prediction and barriers associated with parallel code scheduling, but requires a significant quantity of compare instructions. Although compare instructions can be scheduled in parallel, they can consume significant computing resources, especially for switch statements with a large number of cases.

Based on the foregoing, it would be advantageous to provide a design that efficiently and effectively employs switch statements in high speed processor architectures, such as the Itanium architecture, and minimizes those drawbacks associated with previous switch statement code.

### SUMMARY OF THE INVENTION

According to a first aspect of the present design, there is presented a method for coding a switch based on a variable. The method comprises initializing a predetermined quantity of bits in a rotating predicate register file to zero, setting one bit from the predetermined quantity of bits in the rotating predicate register file to one based on a value in a general register, and performing a single case statement function computation related to the one set bit in the rotating predicate register file.

According to a second aspect of the present invention, there is provided a method for coding a switch based on a variable. The method comprises copying at least one nonzero bit from a setting register to a corresponding bit in a rotating predicate register file by moving said bit into the rotating predicate register file, and performing a single case function computation based on the corresponding bit in the rotating predicate register file.

According to a third aspect of the present invention, there is provided a method for coding a switch based on a variable. The method comprises initializing one bit of a virtual predicate register file associated with the variable to one, setting all remaining bits of the virtual predicate register file to zero, writing an address in a general register file into a register rename base, and performing a single case statement function computation based on an index resulting from a modulo sum of the register rename base address combined with a virtual predicate register file address.

These and other objects and advantages of all aspects of the present invention will become apparent to those skilled in the art after having read the following detailed disclosure of the preferred embodiments illustrated in the following drawings.

### DESCRIPTION OF THE DRAWINGS

The present invention is illustrated by way of example, and not by way of limitation, in the figures of the accompanying drawings in which:

FIG. 1 is a functional block diagram of a processor having the ability to operate in accordance with the design employed herein;

FIG. 2A is one typical construct of a switch statement in C computer language;

FIG. 2B is another typical construct of a switch statement in C;

FIGS. 3A and 3B illustrate non-predicated and predicated code segments, respectively;

FIGS. 4A, 4B, and 4C show an example of coding of a typical if-then-else statement, with FIG. 4A showing a prior if-then-else code segment, FIG. 4B the computation of the “if” and “else” segments, and FIG. 4C the Itanium architecture construction of the equivalent code;

FIG. 5A illustrates a switch statement using the traditional sequential evaluation structure;

FIG. 5B shows the determination of six predicates;

FIG. 5C presents the six Itanium compare instructions corresponding to the evaluation of FIG. 5A;

FIG. 6 is the Itanium architecture move to predicates instruction;

FIG. 7 illustrates a typical switch statement for variable c;

FIG. 8A is the code for performing the switch statement according to one aspect of the design;

FIG. 8B is the code for performing the switch statement according to another aspect of the design;

FIG. 9 presents code for employing the register rename base for predicate rrb.pr to switch on a variable according to another aspect of the present design; and

FIGS. 10A-10D are graphical depictions of register activities in accordance with the code of Statements (1) through (4).

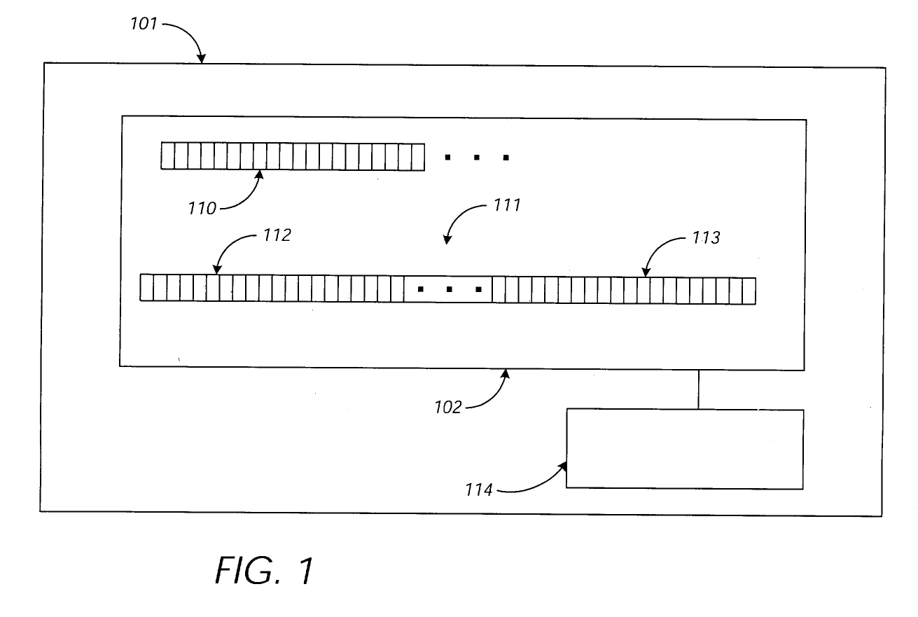

### DETAILED DESCRIPTION OF THE INVENTION

Predicates

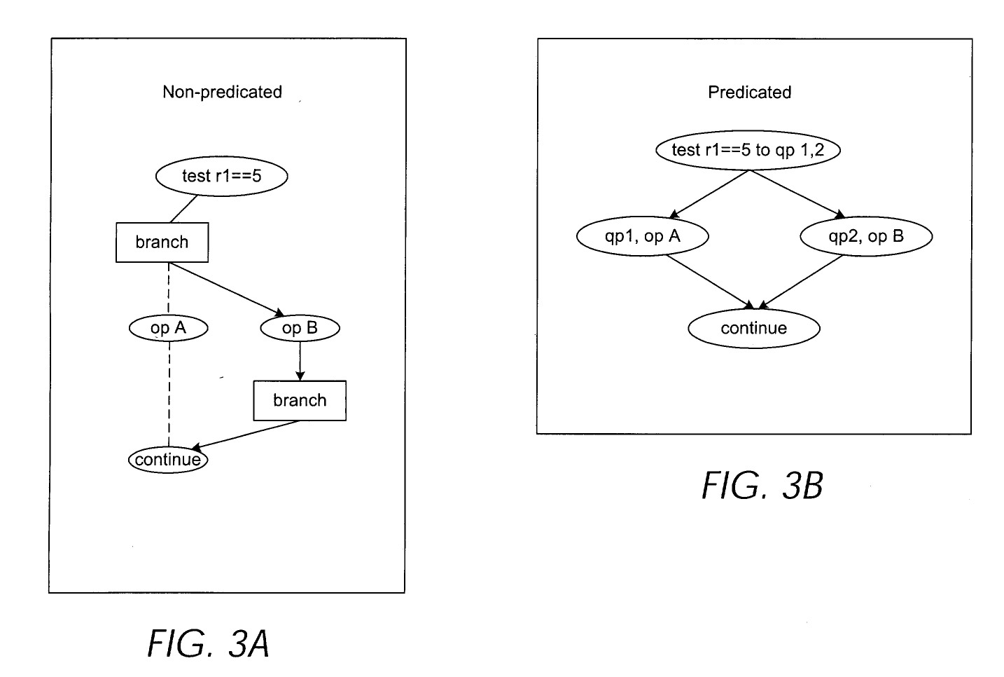

Certain high speed architectures, including the Itanium architecture, employ the concept of predication. Predicates are single bit registers within the processor that can be set based on the result of compare operations. One example of the concept of predication is illustrated in FIGS. 3A and 3B. Predication allows the compiler to eliminate an unpredictable branch. FIG. 3A shows operation of a conditional branch, wherein a test condition is employed and the code at option A or option B is executed depending on the results of the test. Misprediction of such a conditional branch can cause loading and execution of the wrong code, resulting in time delays and lost execution opportunity. A processor can achieve increased efficiency if it can execute both paths of the branch in parallel and can enable the results from the correct path with a single bit. Such a construction is a compiler technique called an if-conversion. FIG. 3B shows a predicated version of the same sequence, wherein the branch is removed. In FIG. 3B, if the result of the test indicates qp1 is the appropriate predicate, option A is executed with the proper variables loaded and available. The Itanium architecture uses predication and supports 63 addressable predicate registers, and those predicates control the vast majority of processor instructions.

Predication of instructions thus involves specifying the predicate register to contain either a one or a zero. If a particular predicate register contains a one, instructions specifying that particular predicate register as their qualifying predicate execute normally. If the particular predicate register contains a zero, instructions specifying that particular predicate register as their qualifying predicate do nothing, or in other words execute as nops (no operation instructions).

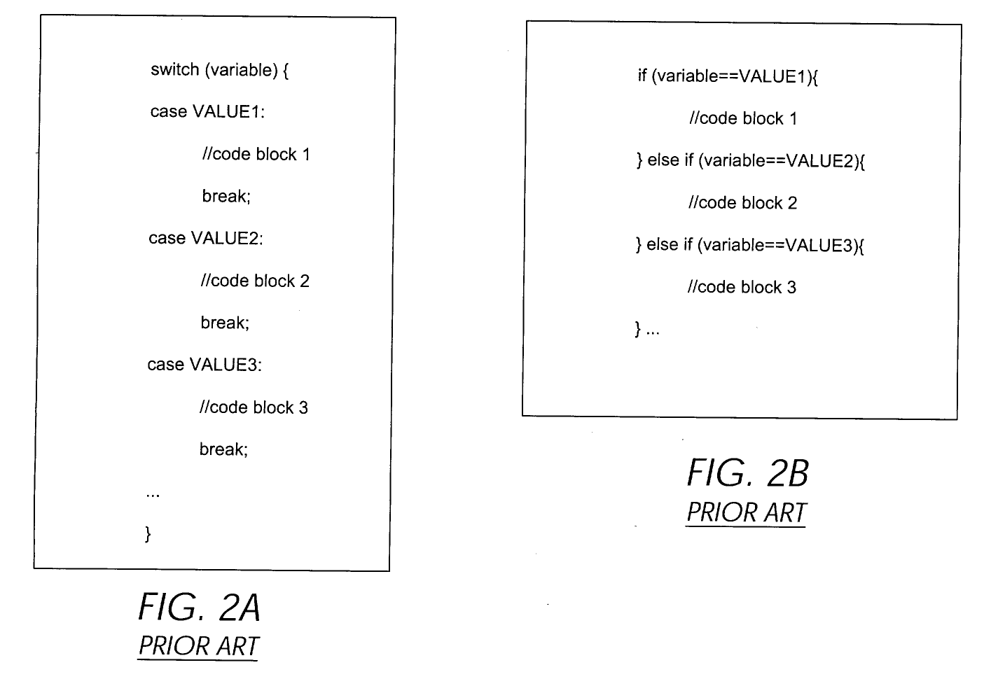

Predication allows control flow dependencies to be transformed into data dependencies. The processor decides which code block to branch to and translates this branching into data dependencies. The processor may compute separate predicates for each case statement block. The processor can predicate instructions from each block on the corresponding predicate register. In other words, in the example shown in FIG. 2A, the statement “case VALUE2” may have a separate predicate, distinct from the predicate for “case VALUE3.” If the predicate for “case VALUE2” is one, the processor executes the instructions associated with “case VALUE2,” namely code block 2.

Use of predicates in this manner allows concurrent free scheduling of all the instructions from the various case statement case blocks. No branching is required to determine instructions to be executed. All instructions from all appropriate case statements execute. However, only one case statement body has a predicate equal to one, and so only instructions from that case statement code body produce results.

Removal of branching using predicates allows for greater parallelism. Although certain instructions will have a predicate register containing zero and thus execute as a no operation, these no operations will execute in functional units that typically would have otherwise remained idle. Additionally, removal of branches eliminates the possibility of branch mispredictions.

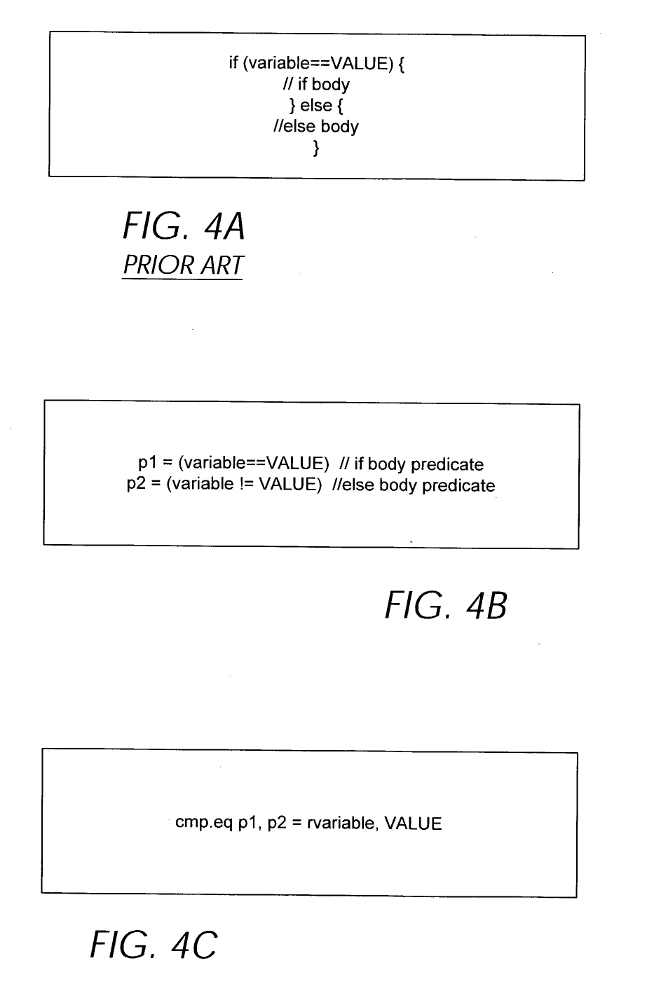

Unlike simple if-then-else clauses using branching, computation of predicate values can be involved. For example, FIG. 4A illustrates a simple if-then-else block. Computation of predicates in compiled machine code that employs if-conversion requires calculation of two predicates, one for the “if” body, and one for the “else” body, and the computation is as shown in FIG. 4B. From FIG. 4B, predicate p1 is set to a 1 if variable is found to be equal to VALUE, and to 0 otherwise. Predicate p2 is set to a 1 if variable is found not to be equal to VALUE, and 0 otherwise. In the Itanium architecture, the computation of the two predicates p1 and p2 can be performed using the one machine instruction of FIG. 4C. The Itanium instruction of FIG. 4C is equivalent to that of FIG. 4B, where p1 and p2 are the two predicates computed, rvariable represents the register where variable is located, and VALUE the value against which rvariable is compared to determine predicates p1 and p2.

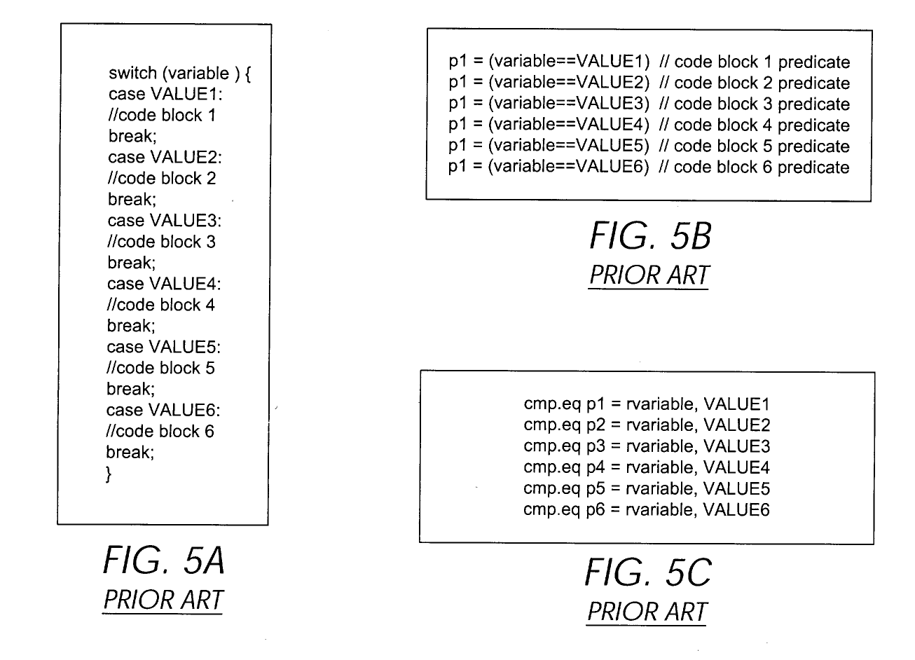

For switch statements having more than two cases, more predicates are required than those illustrated in FIGS. 4A, 4B, and 4C. Computation of more predicates requires additional instructions. As shown in FIG. 5A, a switch statement using the traditional sequential evaluation structure may switch based on the value of variable according to six values, and would subsequently branch to the associated code block. FIG. 5B shows the determination of the six predicates, while FIG. 5C presents the six Itanium compare instructions corresponding to the evaluation of FIG. 5A. Although parallel computation of predicates and parallel execution of predicated case statement instructions can be an improvement over the sequential compare-and-branch approach, from a computational perspective, minimizing the number of compare instructions required in the Itanium environment is highly desirable.

Often, the set of values to be compared against in switch statements such as the equivalent of the statement of FIG. 5A are clustered within a narrow range. For example, in the switch statement of FIG. 5A, the values to be compared against might be VALUE1 equals 0, VALUE2 equals 1, VALUE3 equals 2, VALUE4 equals 3, VALUES equals 5, and VALUE6 equals −1. The result of predicate setting will be that at most one of the case body predicates will be one, and the remainder will be zero. In the example of FIG. 5A, at most one of the six values will be equal to variable and the case statement body corresponding to the specific value equal to the variable is executed while other case statement bodies are not. The present design sets the case body predicates by initializing a range of predicates to zero and uses the variable to be tested in the switch statement to indirectly address one of the static predicate registers or rotating predicate registers.

With respect to the terminology employed herein, one set of 64 predicate registers is employed in the Itanium architecture. 16 predicate registers are statically addressed, meaning that the register number used in instructions to reference a particular predicate register always maps to the same physical register. 48 of the predicate register are termed “rotating predicates.” The register number used in instructions to reference a particular predicate register goes through a mapping to determine which predicate register to access. This mapping can be changed under software control, and since the mechanism controlling the mapping function effectively shifts the mapping by one each time, the appearance to software is that this re-mappable portion of the predicate register file “rotates”.

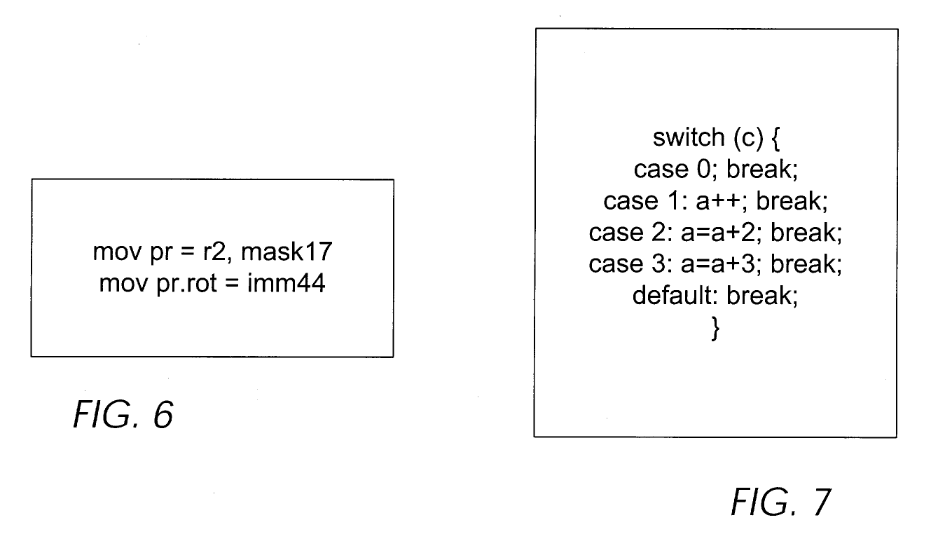

The Itanium move to predicates instruction is as shown in FIG. 6. Again, the Itanium design operates using 64 predicate registers, where 48 rotate and 16 are static. The first instruction illustrated in FIG. 6 copies general register (GR) bits to corresponding predicate registers (PR). For each static predicate, the mask determines whether the instruction writes to the static predicate or does not write to the static predicate. The mask also determines for the rotating predicates as a group whether the instruction writes to the rotating predicates or does not write to the rotating predicates. The second statement in FIG. 6 copies a sign extended 28 bit immediate value, imm44, into the 48 rotating predicates.

The present design adds one instruction to the two instructions shown in FIG. 6. The single added instruction sets a single predicate to one.

Operation

According to a first aspect of the present design, an instruction sets one of the 48 rotating predicates to 1, such as that specified by the value r3. The applicable code statement is:

setpr pr.rot[r3] (1)

setpr sets predicate registers. pr.rot specifies the rotating portion of the predicate register file. According to this instruction, the value of the general register specified by r3 is used to select one of the predicate registers, and that register is set to 1. One example of a switch statement using the code statement of Statement (1) is as shown in FIG. 7. From FIG. 7, Case 0 does nothing. Case 1 increments the variable a by one, case 2 increments a by 2, and case 3 increments a by three. Thus if switch variable c is equal to one, a is incremented; if c is two, a is increased by two, and so forth. In this example, the system employs the value of c to compute predicates for each case statement. The processor may perform a bounds test on the switch variable, c, to determine whether c is within a desirable or predetermined range. In this example, a value in excess of 3, or less than 0 if c is a signed variable, is considered out of bounds.

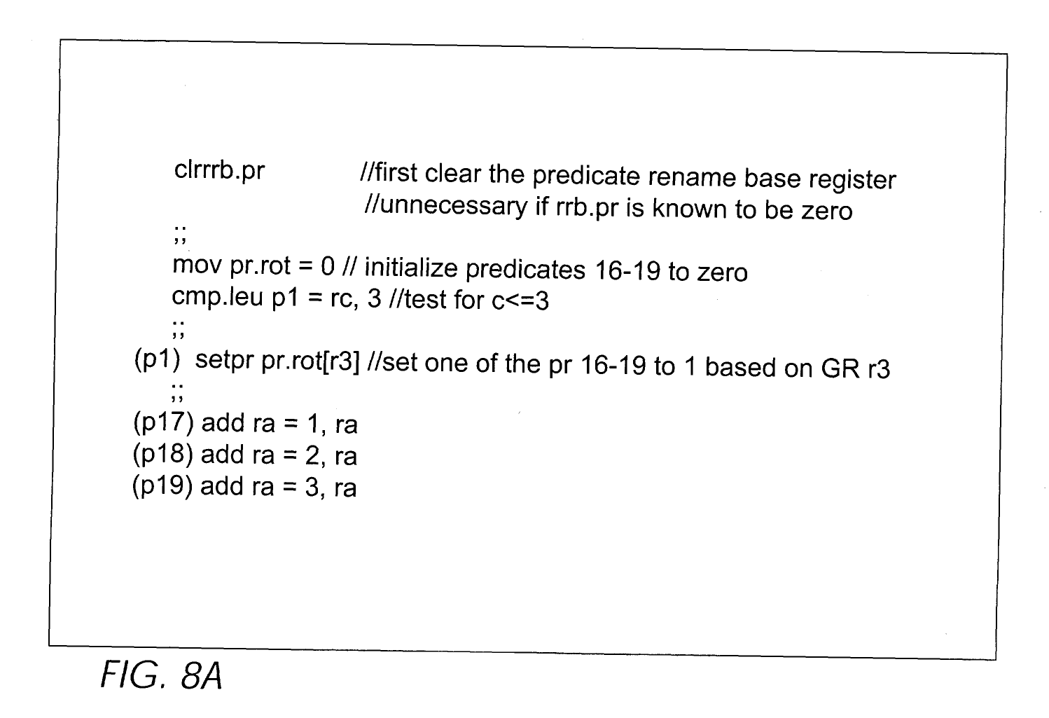

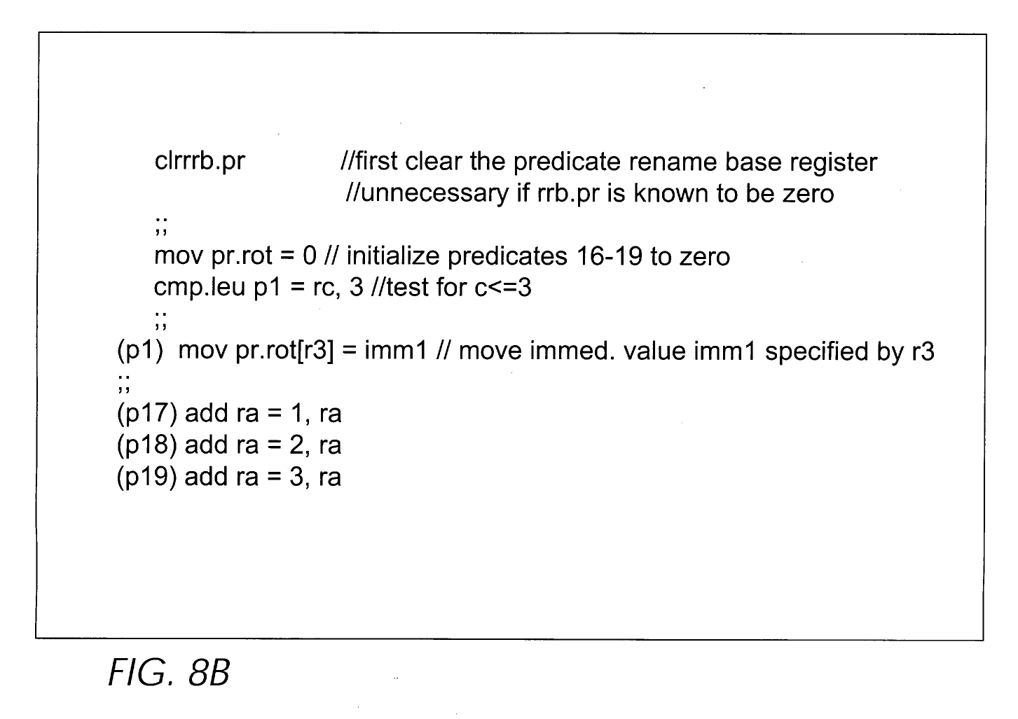

An illustration of this aspect according to the present Itanium design is presented in FIG. 8. The command clrrrb.pr clears the register rename base for predicate, an unnecessary command if the processor knows the register rename base for predicate is set to zero. The second statement initializes applicable rotating predicate registers, here registers 16-19, to zero. mov is a move command, while pr.rot specifies the rotating portion of the predicate register file. cmp.leu computes whether a value is less than or equal to another value, and in the code of FIG. 8A this cmp.leu statement tests the boundary condition. If the value is outside the specified range, the processor sets p1 to 0. Here, if register 3 (r3) is less than or equal to three, the processor sets predicate p1 to 1. Otherwise, predicate p1 is set to 0. The various qualifying predicate register specifiers are presented in parentheses in FIG. 8, where the setpr instruction uses the value in register r3 to set one of the rotating predicate registers 16, 17, 18, or 19 to 1 when p1 has the value 1, and does nothing otherwise. The instructions predicated on rotating predicate registers 17, 18, and 19 execute the applicable case statements or code blocks when the predicate has the value 1, specifically incrementing register a by one, two, or three. In the default case, no action is required and no additional instructions are performed in the default case.

This aspect of the design thus initially clears the rotating predicates, performs a boundary condition test, and sets at most one bit in the rotating predicate register specified by a value in a general register to 1. Code blocks, or case statements or case statement functions, are then executed as appropriate.

An alternate aspect of the current design is employing an instruction such as:

mov pr.rot[r3]=imm1 (2)

imm represents an immediate value. The instruction shown in Statement (2) can be employed in a similar manner to the implementation shown in FIG. 8A for Statement (1), and the specific implementation of Statement (2) is shown in FIG. 8B. From FIG. 8B, the value to be written into the selected predicate register (selected by the general register specified by r3) comes from the immediate value. The value written to the predicate register is either 0 or 1.

With respect to immediate values, Itanium-based processors support a path from immediate bits to rotating predicate bits via the instruction:

mov pr.rot=imm44

In the Statement (2) instruction mov pr.rot[r3]=imm1, an immediate value imm1 of 0 provides zeroes in all bit positions, so the system writes the bit selected by GR[r3] to zero. In this instance, if GR[r3] had a value of 17, the zero value in the immediate register would be moved into rotating predicate register 17. The instruction thus takes the 1-bit immediate value and copies the value into the predicate register selected by the value of GR[r3]. As implemented, the instruction sign extends the 1 bit immediate value to 64 bits, selects the particular predicate register for writing based on the value in GR[r3], and copies the bit in the 64 bit sign-extended immediate corresponding to the particular predicate register into the predicate register. In this instance, if r3 had a value of 18, the system would move the one value in the immediate value into the rotating predicate register at bit 18. Thus in this aspect of the invention, the rotating predicate registers are cleared, a boundary condition tested, a single register in the rotating predicate register set is rapidly selected based on the value received from a remote register, here r3, and the selected bit of the rotating predicate register set to the value of the immediate operand in the instruction.

As used herein, the term “setting register” can mean any register generally employed to set a predicate register, a rotating predicate register, or a static predicate register. The term setting register includes but is not limited to a general register, a remote general register, and a remote register.

An additional aspect of the present invention entails setting the appropriate predicate register based on the value contained in a remote register or remote general register:

mov pr.rot[r3]=r2 (3)

Itanium supports a path connecting each bit position in a general register source to the corresponding predicate register. This instruction would operate much as Statement (2) above, except that once the particular predicate register to write is selected by a register source, the value to write could come from the corresponding bit position in the other source, here r2. In other words, if register r3 indicates rotating predicate 17 is to be selected and written, the value to be written comes from bit 17 in register r2. Thus in this aspect of the invention, the rotating predicate register is cleared, a boundary condition is tested, and a bit in the rotating predicate register set is set to the contents of a general register (r2) based on the value specified by another register (r3).

Another aspect of the current invention employs the following statement:

mov rrb.pr=r3 (4)

In this aspect of the present design, the system employs register renaming, a feature present in the Itanium design used in conjunction with rotating predicates. rrb is the register rename base, and the “.pr” suffix indicates the register rename base for the rotating predicate registers. Although rrb.pr is typically employed in predicate register read and write ports to rename the predicate registers, this renaming is ignored by the processor for the broad “move to predicates” instruction. The reason the processor ignores the register renaming on broad move instructions is because such renaming could require the move instruction to operate as a barrel shifter, which is generally undesirable. Effectively, the processor uses the register rename base for predicate to map the virtual rotating predicate registers onto rotating predicate registers as follows:

pr_number=virtual_pr_number+rrb.pr

The virtual predicate register number specified in an instruction, virtual_pr_number, plus register rename base for predicate, rrb.pr, equals the predicate register number, pr_number, which determines the actual predicate register to be accessed by the instruction. Predicates may be moved using mov pr=gr (moving the general register value(s) into the predicate registers), or mov pr.rot=imm44 (moving the immediate value into the rotating predicate registers). In each case, the processor writes each bit in the general register or immediate value to the corresponding predicate register, without register renaming. If rrb.pr, the register rename base for predicate, is nonzero, subsequent accesses of individual predicates employ renaming. If rrb.pr is zero, no renaming occurs.

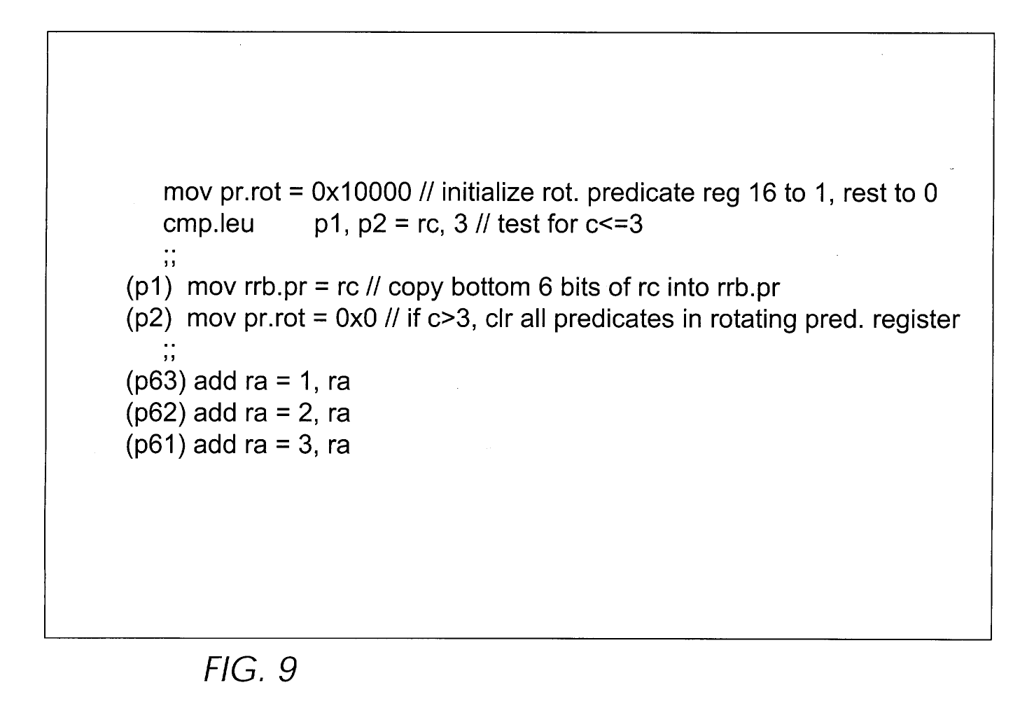

The present aspect of the design thus sums a virtual or software based predicate register value in combination with register rename base register for predicate, rrb.pr. One example of this movement is presented in FIG. 9, which performs the switch (c) switch illustrated in FIG. 7. From FIG. 9, mov pr.rot initializes the predicate register number 16 to one, and all other rotating predicate registers to zero. The second statement, cmp.leu, performs a boundary test by verifying c is less than or equal to three. The two predicated statements p1 and p2 operate as follows. The first mov statement copies bits from general register rc (containing the value of the variable c), into the register rename base for predicate, rrb.pr. The second predicated statement clears all rotating predicates if c is greater than three, effectively setting all bits in the rotating predicate register to zero if c is greater than three. Thus in operation, this aspect adds a qualifying predicate specifier to the value in rrb.pr, performs a modulo function subtracting 48 if the result of the addition is greater than 64, thereby producing an address. The system executes the case statement associated with that resultant address. In summary, this aspect evaluates a boundary condition on the switch variable, and if the variable is within bounds the system sets the bit in the rotating predicate register file corresponding to the case statement to be executed. If the variable is outside the boundary, the system clears all predicates.

Another aspect of the present design addresses boundary condition testing. In the foregoing aspects of the design, the variable switched is evaluated to determine whether it is within a predetermined range. If the switch variable is outside the predetermined range, a default code is enabled, such as a no operation command. A further aspect of the current system checks the move to predicate indirect (mov pr.rot) instruction or the move to rrb.pr instruction to evaluate whether the value being moved is larger than 47, the size of the rotating predicate buffer. In the event the instruction is larger than 47, the instruction is treated as if it were 47. This obviates the need to check boundary conditions, such as the evaluation “cmp.leu p1, p2=rc, 3” performed in FIGS. 8A, 8B, and 9. Any of the foregoing aspects may employ this aspect to minimize comparisons within the switch code. Thus this aspect of the design entails assessing the move instruction where register values are copied into the predicate register or rotating predicate register and if the value being moved is outside a boundary, the value is treated as the boundary condition. In this aspect, predicate register testing is free of boundary condition testing within the switching logic.

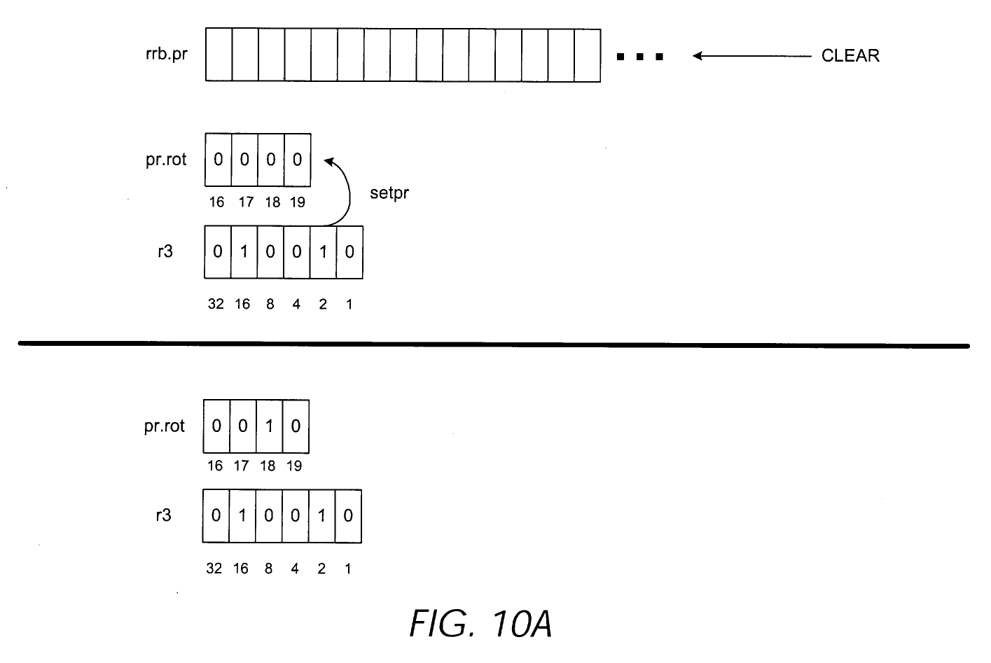

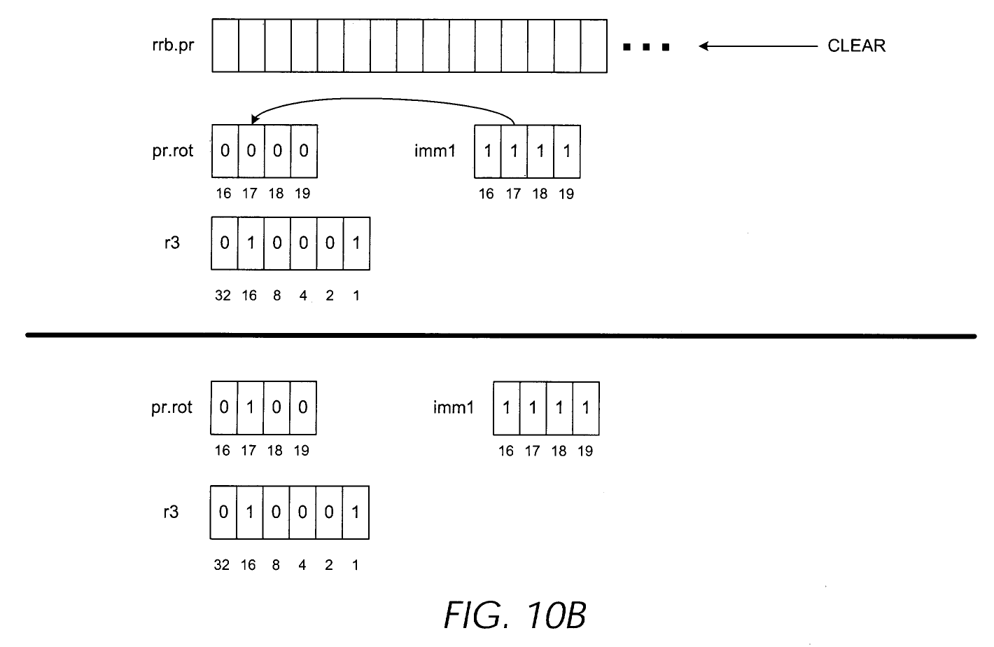

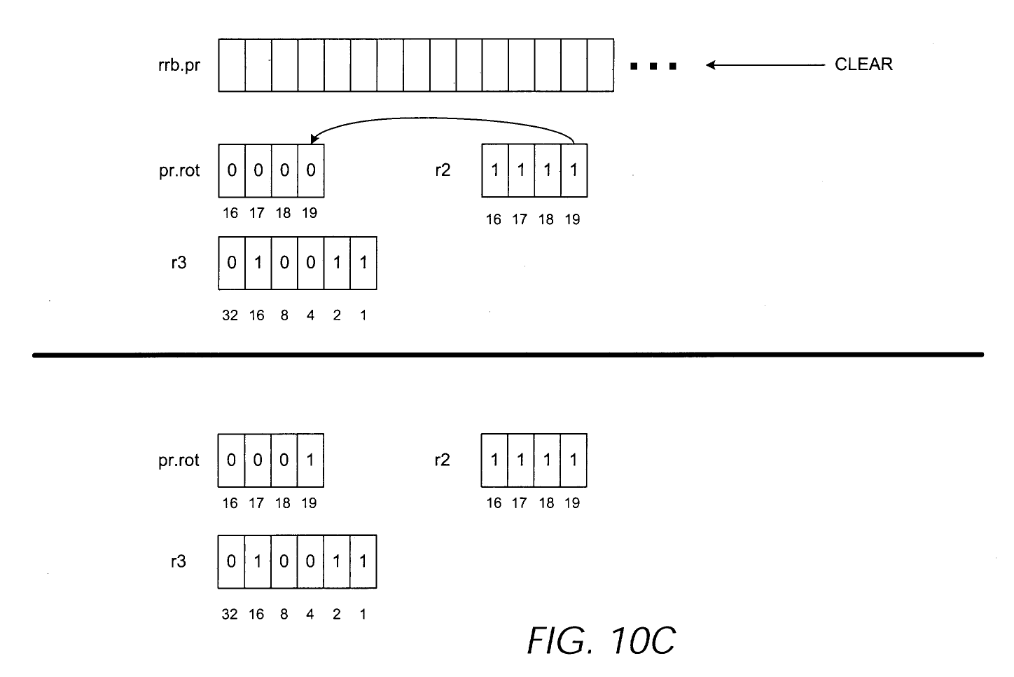

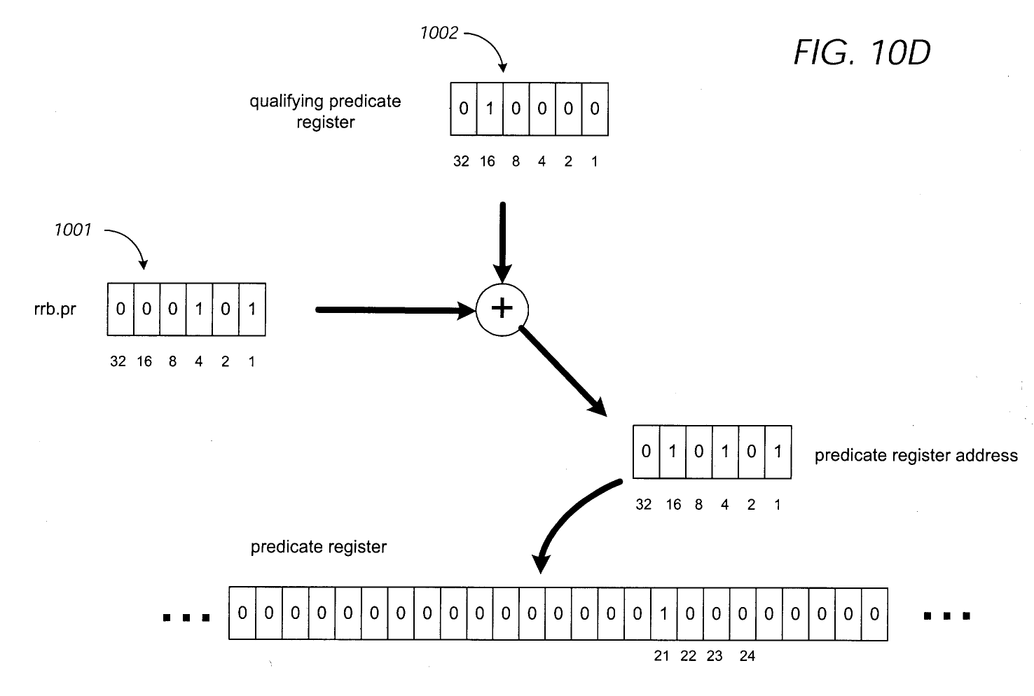

Conceptual depictions of the design depicted in Statements (1) through (4) above are presented in FIGS. 10A, 10B, 10C, and 10D. From FIG. 10A, the processor initially clears the register rename base for predicate rrb.pr so that rotating predicate registers are not renamed. Since only 48 rotating predicate registers exist, rrb.pr does not need to be very large, and may in typical circumstances hold only six bits. From FIG. 10A, the initial condition is pr.rot being cleared while one bit of register r3 is set. The subsequent condition is the alteration of pr.rot. In this example and in all examples shown in FIGS. 10A-10D, only the first four rotating predicate registers, labeled 16-19, are available for setting. Additional bits are present but not shown in certain registers depicted in FIGS. 10A-10D. In accordance with r3, bit 18 is set in the subsequent frame example of FIG. 10A.

Statements (2) and (3) as shown in FIGS. 10B and 10C require clearing of the register rename base for predicate rrb.pr. FIG. 10B, corresponding to Statement (2) above, illustrates a cleared pr.rot register initially. The one bit from imm1 is moved into bit 17 of the pr.rot register. FIG. 10C, corresponding to Statement (3) above, illustrates a cleared pr.rot register initially, followed by the copying of register bit 19 in register r2, as specified by an r3 value of 19, into the predicate register 19. Finally, Statement (4) above corresponds to FIG. 10D. FIG. 10D shows a nonzero rrb.pr 1001. The register rename base for predicate rrb.pr holds a small number representing the offset between register numbers specified in instructions and physical register numbers, in this instance a six bit quantity having a value of 5, or 000101. When the processor clears rrb.pr and no renaming occurs, rrb.pr holds the value 0. The processor takes the virtual or qualifying predicate register specifier 1002, here 16, or 010000, adds this qualifying predicate register specifier to the contents of the rrb.pr register, and reduces the result by 48 if the result is greater than 64. The reduction by 48 corresponds to 64 available registers minus 16 static registers, and 48 thus represents the number of available rotating predicate registers. Here, 16 or 010000, plus 5, or 000101, equals 21, or 010101, which is not greater than 64. In operation, if the predicate register having address 21 contains a 1, the system will execute the associated case statement. If the predicate register having address 21 contains a 0, the system will not execute the associated case statement. With respect to exceeding the value of 64, one example is a rrb.pr value of 20 or 010100 added to an qualifying predicate register specifier of 59 or 111011 yields 79 which exceeds the predicate register limit. In this case, the resultant value is 010100 plus 111011, a total of 1001111 minus 110000 (48) yielding 011111 or 31.

It will be appreciated to those of skill in the art that the present design may be applied to other systems that perform computational functions, such as other high speed computation processes besides those present in the Itanium architecture. In particular, it will be appreciated that any type of switching functions may be addressed by the predication functionality and associated aspects described herein.

Although there has been hereinabove described a method and for performing switch statements using predicates, for the purpose of illustrating the manner in which the invention may be used to advantage, it should be appreciated that the invention is not limited thereto. Accordingly, any and all modifications, variations, or equivalent arrangements which may occur to those skilled in the art, should be considered to be within the scope of the present invention as defined in the appended claims.

What is claimed is:

1. A method for coding a switch based on a variable, comprising:
initializing a predetermined quantity of bits in a rotating predicate register file to zero;
setting one bit from the predetermined quantity of bits in the rotating predicate register file to one based on a value in a general register; and
performing a single case statement function computation related to the one set bit in the rotating predicate register file.

2. The method of claim 1, further comprising testing the variable for a boundary condition, said testing comprising evaluating whether the variable is within a predetermined range.

3. The method of claim 2, wherein said predetermined range corresponds to a range in the rotating predicate register file corresponding to the predetermined quantity of bits.

4. The method of claim 1, further comprising:
clearing a predicate rename base register when said register rename base register is nonzero prior to setting.

5. The method of claim 1, wherein setting comprises moving values into the rotating predicate register file.

6. The method of claim 5, further comprising testing the index values to determine whether said index values each exceed an acceptable range, said testing occurring prior to said setting.

7. The method of claim 6, further comprising setting the value to be within the acceptable range when the value is determined to exceed the acceptable range.

8. The method of claim 1, said method requiring fewer comparisons than a comparably functioning if-then-else statement.

9. A method for coding a switch based on a variable, comprising:
copying at least one nonzero bit to a corresponding bit in a rotating predicate register by moving said bit into the rotating predicate register; and
performing a single case function computation based on the corresponding bit in the rotating predicate register.

10. The method of claim 9, further comprising initializing a predetermined quantity of bits in the rotating predicate register to zero prior to said copying.

11. The method of claim 9, wherein the nonzero bit copied comprises an immediate value.

12. The method of claim 9, wherein the nonzero bit copied originates from a setting register.

13. The method of claim 9, further comprising testing the variable for a boundary condition, said testing comprising evaluating whether the variable is within a predetermined range.

14. The method of claim 13, wherein said predetermined range corresponds to a range in a rotating predicate register file corresponding to the predetermined quantity of bits.

15. The method of claim 9, further comprising:
initially clearing a register rename base register if said register rename base is nonzero.

16. The method of claim 9, said method requiring fewer comparisons than a comparably functioning if-then-else statement.

17. The method of claim 9, further comprising testing values used to index the rotating predicate register to determine whether said values exceed an acceptable range, said testing occurring prior to said copying.

18. A method for coding a switch based on a variable, comprising:
initializing one bit of a virtual predicate register file associated with the variable to one;
setting all remaining bits of the virtual predicate register file to zero;
writing an address in a general register file into a register rename base; and
performing a single case statement function computation based on an index resulting from a modulo sum of the register rename base address combined with a virtual predicate register file address.

19. The method of claim 18, further comprising testing the variable for a boundary condition, said testing comprising evaluating whether the variable is within a predetermined range.

20. The method of claim 19, wherein said predetermined range corresponds to a range of available bits in the predicate register file.

21. The method of claim 18, said method requiring fewer comparisons than a comparably functioning if-then-else statement.
